(19) United States
(12) Patent Application Publication
(10) Pub. No.: US 2007/0200691 A1
(43) Pub. Date: Aug. 30, 2007

(54) Vehicle collision recorder

(76) Inventors: Albert Lam, Hong Kong (CN); YanLong Han, Guangdong (CN)

Correspondence Address: Raymond Y. Chan, Suite 128, 108 N. Ynez Avenue, Monterey Park, CA, 91754, US

(21) Appl. No.: 11/580,376

(22) Filed: Oct. 12, 2006

(30) Foreign Application Priority Data
Feb. 28, 2006 (CN) 200610034066.8
Mar. 21, 2006 (CN) PCT/CN06/00451

(51) Int. Cl. B60Q 1/00

(52) U.S. Cl. 340/436

(57) ABSTRACT

A vehicle collision recorder includes a CUP module, an image capturer for real-time capturing an image of a route of a vehicle, a power unit for activating the CUP module and the image capturer when the vehicle is started, and an impact switch operatively linked to the power unit, wherein the impact switch is activated via a force of inertia to automatically turn off the power unit so as to deactivate the image capturer for stop capturing the image, such that the image is saved with a time range before the power unit is turned off for illustrating the fact in process of collision.

### BACKGROUND OF THE PRESENT INVENTION

1. Field of Invention

The present invention relates to a traffic monitoring device, and more particularly to a vehicle collision recorder which can automatically self-activate to start live-time recording the driving route before and after the accident.

2. Description of Related Arts

Most drivers hardly find a witness eye-witnessing an event when the drivers have a traffic violation or a traffic accident. In most cases, the police officer generally writes up a police report by observation such that both parties involving in the accident will not be satisfied finally. In addition, the police officer will usually take all the necessary photos and try to illustrate the detail of such event according to the experience of the police officer. However, the photos can only illustrate the result of the accident, such as how serious the vehicle is damaged, in a sheet-by-sheet manner. Using a camcorder to record the fact of the event is considered as one of the best way to show all necessary information in a motion picture manner. However, the cost of the camcorder is relatively high and the installation of the camcorder is complicated. Thus, the camcorder has a very limited recording capacity. Many cities already have extensive traffic monitoring system to monitor congestion and notice accidents. The traffic monitoring system is commonly known as closed circuit television (CCTV) or Internet system for video capturing. However, such traffic monitoring system has several drawbacks. The cost of the traffic monitoring system is relatively high. The installation of the traffic monitoring system is complicated. Thus, such of the traffic monitoring system has a limited monitoring distance and a fixed monitoring coverage that the capturing input of the system cannot be moved.

### SUMMARY OF THE PRESENT INVENTION

A main object of the present invention is to provide a vehicle collision recorder which can automatically self-activate to start live-time recording the driving route before and after the accident.

Accordingly, in order to accomplish the above object, the present invention provides a vehicle collision recorder, comprising, a CUP module, an image capturer electrically connecting to the CUP module for capturing an image, a power unit electrically connecting with the CUP module and the image capturer for electrically connecting to a power source of a vehicle, and a mounting kit, which supports the image recorder, comprising a housing for mounting to the vehicle.

The vehicle collision recorder further comprises an image processor which comprises an image decoder, a data storage and a data port. The image decoder is operatively connecting to the image capturer for decoding the image captured therefrom into an image data through a built-in decoding program. The data storage is operatively connecting to the CUP module, the image decoder and the image capturer. The data port is communicatively linked to the data storage.

A switch unit, which is electrically connected to the power unit to control the CUP module, the image capturer, and the image decoder, comprises an impact switch and a manual switch.

The present invention further provides a process of managing the image data of the vehicle collision recorder, comprising the following steps.

(1) Search the data storage to locate an image file at the initial index position.

(2) Search the data storage to locate the image file at the last index position.

(3) Delete the image file at the last index position from the data storage.

(4) Amend the name of the image file and rearrange the image file that the index position of the image file is moved to the next index position thereof in sequence. For example, the image file at the first index position will be moved to the second index position and so on.

(5) Collect an image data, such as motion image data, from the image decoder, wherein the image data is captured by the image capturer. Accordingly, in the step (1), if there is no image file stored in the data storage, the step (1) can direct jump to the step (5) to omit the steps (2), (3), and (4).

(6) Save the image data as the image file in the data storage at the initial index location thereof.

(7) Convert the image file at the initial index position of the data storage into a video file as a newly added video file, i.e. the latest video file.

(8) Search the name of the newly added video file matching with saved video files in the data storage.

(9) If the name of the newly added video file matches with one of the saved video files in the data storage, overwrite the saved video file with the newly added video file.

(10) If the name of the newly added video file does not match with any of the saved video files in the data storage, save the newly added video file in the data storage. Then, return back to the step (1).

According to the preferred embodiment, the image capturer can be made by “Sonix-SN9C101+PAS106, SN9C120+AV7660 video capturing module” or “OMINVSION-OV9650, 9653, 9655, 2630, 7670 video capturing module”.

The CPU module, the image decoder, the data storage, and the data port can be individual components. Alternatively, the CPU module, the image decoder, the data storage, and the data port are integrated to form an IC processor.

The activation IC of the decoder can be made of “Sigma-03012A” built-in hard disk decoding processor.

According to the preferred embodiment, the vehicle collision recorder is adapted for live-time capturing the route of the vehicle and for directly saving the captured image to a flash memory. The vehicle collision recorder is adapted to unlimitedly record the image data within a limited storage capacity and to automatically protect the image data before the impact switch switches off the power of the power unit so as to prevent the image data from being erased. In other words, the vehicle collision recorder is adapted to automatically replace the last saved image file by the newly added image file in a loop manner, to rename the filename and to rearrange the order of the file for moving the newly added file at the initial location. The image file is converted into the video file format through a converting program or the internal processor of the image decoder. It is worth to mention that the video file contains the motion image of the route of the vehicle at the time of collision such that after the vehicle is stopped, the driver is able to view the motion image a time range before the power unit is turned off for illustrating the fact in process of collision.

Accordingly, in the car collision accident, the time period of video recording is starts from a few minutes before the accident and ends at approximately 30 seconds after the accident to show the evidence of the accident. The present invention is adapted to video record the corresponding time period to reduce the course of the production and to generalize it in the consumer market. This advantage can further lower the price in comparison with the existing expensive recording equipment in the market such that the present invention is affordable for everyone who wants to capture the driving route.

It is worth to mention that the present invention is adapted for not only being used for car collision occurrence recording purpose but also serving as a witness to evident other incidents, such as careless driving of other vehicles, accidents of third parties, crimes, terrorist attacks, etc. It will help to improve the safety of the nation.

Therefore, the present invention has the advantages of high integration ability, relatively small in size, relatively low power consumption, ease of operation, ease of detachably installation, and relatively low cost. Thus, the vehicle collision recorder comprises various connectors such as “USB 2.0” for allowing the user to obtain the image file and/or video file from the data storage. Then, the user is able to pull out the video file for proving the fact of the accident so as to solve any uncertain problem of the accident.

### BRIEF DESCRIPTION OF THE DRAWINGS

FIG. 1 is a block diagram of a vehicle collision recorder according to a preferred embodiment of the present invention, illustrating the structural configuration of the vehicle collision recorder.

FIG. 2 is a perspective view of the vehicle collision recorder according to the above preferred embodiment of the present invention.

FIG. 3 is a flow chart illustrating a data processing of the vehicle collision recorder according to the above preferred embodiment of the present invention.

FIG. 4 is a flow chart of the operation of the vehicle collision recorder according to the above preferred embodiment of the present invention.

### DETAILED DESCRIPTION OF THE PREFERRED EMBODIMENT

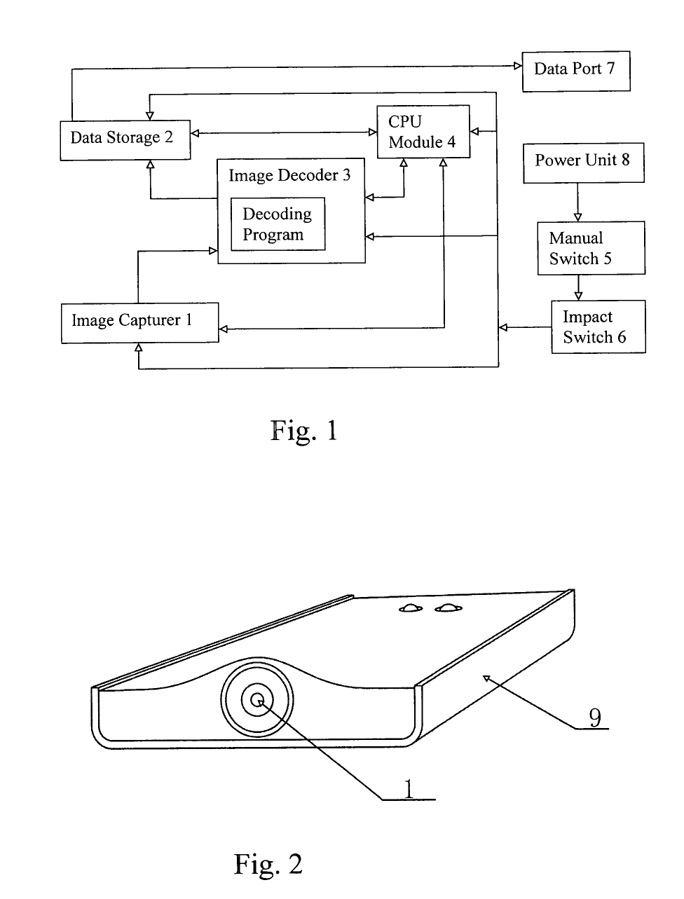

Referring to FIGS. 1 and 2 of the drawings, a vehicle collision recorder according to a preferred embodiment of the present invention is illustrated, wherein the vehicle collision recorder comprises a CUP module 4, an image capturer 1 electrically connecting to the CUP module 4 for capturing an image, a power unit 8 electrically connecting with the CUP module 4 and the image capturer 1 for electrically connecting to a power source of a vehicle, and a mounting kit, which supports the image recorder 1, comprising a housing 9 for mounting to the vehicle such that the image capturer 1 is adapted for capturing the image of a route of said vehicle. Accordingly, the power unit 8 activates the CUP module 4 and the image capturer 1 when the vehicle is started.

The vehicle collision recorder further comprises an image processor which comprises an image decoder 3, a data storage 2 and a data port 7. The image decoder 3 is operatively connecting to the image capturer 1 for decoding the image captured therefrom into an image data through a built-in decoding program. The data storage 2 is operatively connecting to the CUP module 4, the image decoder 3 and the image capturer 1. The data port 7 is communicatively linked to the data storage 2.

The vehicle collision recorder further comprises a switch unit wherein the switch unit comprises a manual switch 5 and an impact switch 6 operatively connecting to the manual switch 1, the CUP module 4, the image capturer 1, and the data storage 2.

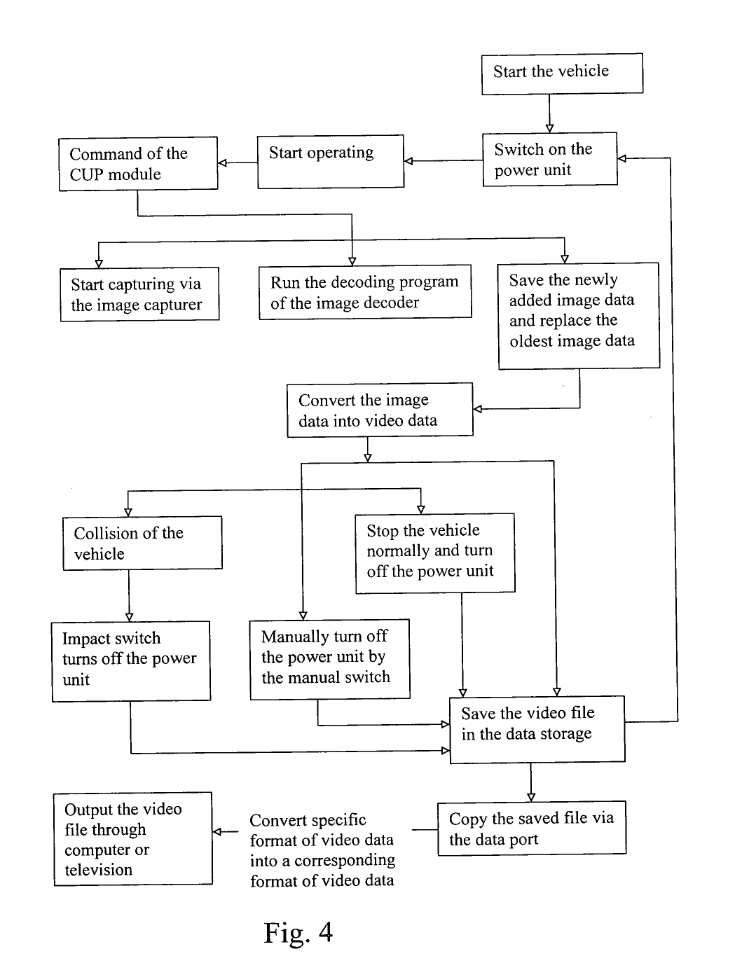

FIG. 4 illustrates the operation of the vehicle collision recorder of the present invention. When the driver starts the vehicle, the vehicle collision recorder is automatically turned on via the power unit 6 for real-time capturing the route of the vehicle as the motion image. In other words, the power unit 6 is automatically switched on when the vehicle is started concurrently. During the collision, the power unit 8 is automatically turned off by the impact switch 6 via the force of inertia or manually turned off by the manual switch 5. In other words, the power unit 8 is automatically turned off to deactivate the image capturer 1 for stop capturing the image. The vehicle collision recorder will save the latest video image before the power unit 8 is turned off. Thus, the user is able to manually turn off the power unit 8 via the manual switch to save the latest video image before the power unit 8 is manually turned off for illustrating the fact in process of traffic violation.

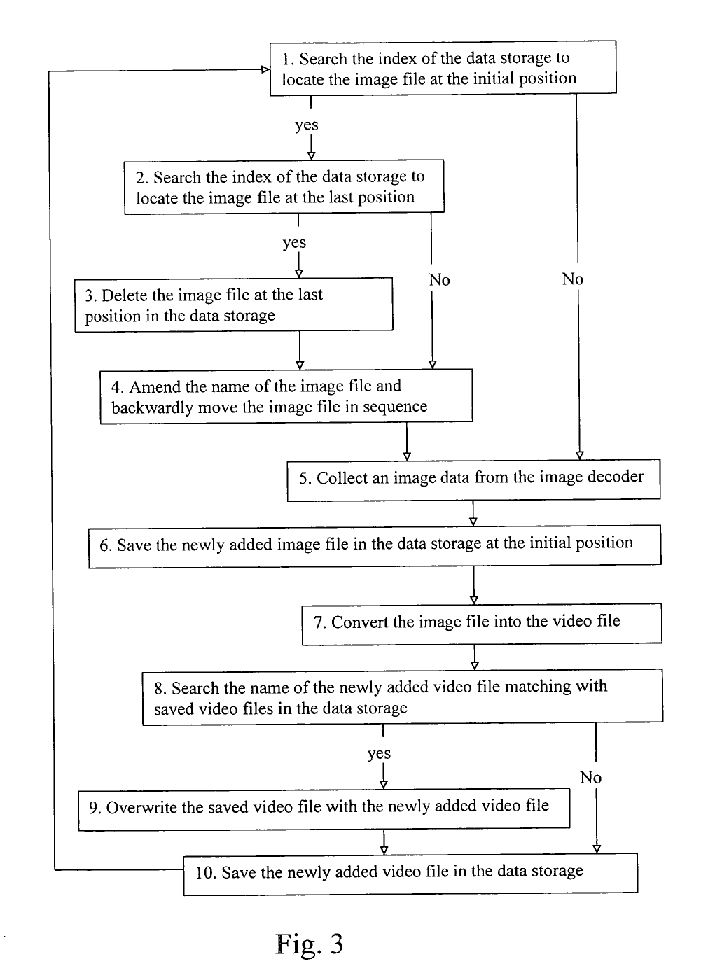

FIG. 3 illustrates the data processing of the vehicle collision recorder of the present invention. The process of managing the image data of the vehicle collision recorder through the CUP module 4 comprises the following steps.

(1) Search the data storage to locate an image file at the initial index position.

(2) Search the data storage to locate the image file at the last index position.

(3) Delete the image file at the last index position from the data storage.

(4) Amend the name of the image file and rearrange the image file that the index position of the image file is moved to the next index position thereof in sequence. For example, the image file at the first index position will be moved to the second index position and so on.

(5) Collect an image data, such as motion image data, from the image decoder, wherein the image data is captured by the image capturer. Accordingly, in the step (1), if there is no image file stored in the data storage, the step (1) can direct jump to the step (5) to omit the steps (2), (3), and (4).

(6) Save the image data as the image file in the data storage at the initial index location thereof.

(7) Convert the image file at the initial index position of the data storage into a video file as a newly added video file, i.e. the latest video file. It is worth to mention that since only image file at the initial index position of the data storage is converted into the video format, the newly added video file can be viewed instantaneously. In other words, the image decoder 1 is arranged for decoding the image captured by the image capturer 1 into the image data and converting the image data into a video format.

(8) Search the name of the newly added video file matching with saved video files in the data storage.

(9) If the name of the newly added video file matches with one of the saved video files in the data storage, overwrite the saved video file with the newly added video file.

(10) If the name of the newly added video file does not match with any of the saved video files in the data storage, save the newly added video file in the data storage. Then, return back to the step (1).

The vehicle collision recorder is adapted to monitor and capturing the motion image of the route of the vehicle, especially to monitor the surrounding of the moving vehicle to enlarge the monitoring coverage. The user or the driver is able to obtain the video file in the data storage or to save the video file therein, wherein the vehicle collision recorder is adapted to unlimitedly record the image data within a limited storage capacity. Thus, the latest video file is always saved by deleting the oldest video file. The video file in the data storage can be extracted out and copied via the data port for being broadcasted through the computer or television.

What is claimed is:

1. A vehicle collision recorder for a vehicle, comprising:
a CUP module;
an image capturer electrically connecting to said CUP module for real-time capturing an image of a route of said vehicle;
a power unit, which is adapted for electrically connecting to a power source of said vehicle, electrically connected to said CUP module and said image capturer in a controllable manner, wherein said power unit activates said CUP module and said image capturer when said vehicle is started;
a mounting kit, which is adapted for mounting to said vehicle, supporting said image capturer such that said image capturer is adapted for capturing said image of a surrounding of said vehicle; and
a switch unit comprising an impact switch operatively linked to said power unit, wherein said impact switch is activated via a force of inertia to automatically turn off said power unit so as to deactivate said image capturer for stop capturing said image, such that said image is saved with a time range before said power unit is turned off for illustrating the fact in process of collision.

2. The vehicle collision recorder, as recited in claim 1, further comprising an image decoder operatively linked to said image capturer for decoding said image into an image data and converting said image data into a video data.

3. The vehicle collision recorder, as recited in claim 1, further comprising a data storage operatively connecting to said CUP module, said image decoder and said image capturer, wherein said data storage is adapted for storing said image captured by said image decoder.

4. The vehicle collision recorder, as recited in claim 2, further comprising a data storage operatively connecting to said CUP module, said image decoder and said image capturer, wherein said data storage is adapted for storing said image captured by said image decoder.

5. The vehicle collision recorder, as recited in claim 4, wherein said data storage is operatively linked to said image decoder for storing said video data.

6. The vehicle collision recorder, as recited in claim 4, wherein said CUP module comprises means for managing said image data in said data storage in an order manner, wherein said managing means rearranges the newly added image data is stored at an initial index position of said data storage while the oldest image data stored at a last index position is deleted from said data storage.

7. The vehicle collision recorder, as recited in claim 5, wherein said CUP module comprises means for managing said image data in said data storage in an order manner, wherein said managing means rearranges the newly added image data is stored at an initial index position of said data storage while the oldest image data stored at a last index position is deleted from said data storage.

8. The vehicle collision recorder, as recited in claim 1, wherein said switch unit further comprises a manual switch operatively connected to said power unit to manually turn off said power unit so as to deactivate said image capturer for stop capturing said image, such that said image is saved with a time range before said power unit is manually turned off.

9. The vehicle collision recorder, as recited in claim 4, wherein said switch unit further comprises a manual switch operatively connected to said power unit to manually turn off said power unit so as to deactivate said image capturer for stop capturing said image, such that said image is saved with a time range before said power unit is manually turned off.

10. The vehicle collision recorder, as recited in claim 7, wherein said switch unit further comprises a manual switch operatively connected to said power unit to manually turn off said power unit so as to deactivate said image capturer for stop capturing said image, such that said image is saved with a time range before said power unit is manually turned off.

11. A method for recording a motion image through a vehicle collision recorder during a collision of a vehicle, comprising the steps of:
(a) switching on a power unit of said vehicle collision recorder when said vehicle is started;
(b) activating an image capturer for real-time capturing said motion image of a route of said vehicle when said power unit is turned on, wherein said image capturer is mounted at said vehicle at a predetermined position for allowing said image capturer for capturing said motion image of said route of said vehicle;
(c) automatically switching off said power unit by an impact switch of said vehicle collision recorder via a force of inertia after collision so as to deactivate said image capturer for stop capturing said motion image; and
(d) saving said motion image in a data storage of said vehicle collision with a time range before said power unit is turned off for illustrating the fact in process of collision.

12. The method, as recited in claim 11, wherein the step (d) further comprises a step of decoding said motion image into an image data and converting said image data into a video data to be save in said data storage.

13. The method, as recited in claim 11, further comprising a step of (e) managing said image data in said data storage, wherein said managing step comprises the sub-steps of:
(e.1) searching said data storage to locate an image file at an initial index position;
(e.2) searching said data storage to locate an image file at a last index position;
(e.3) deleting said image file at said last index position in said data storage;
(e.4) rearranging said image file that said index position of said image file is moved to the next index position thereof in sequence; and
(e.5) saving said image data as an image file at the initial index position of said data storage such that the newly added image data is stored at the initial index position of said data storage while the oldest image data stored at a last index position is deleted from said data storage.

14. The method, as recited in claim 11, wherein the step (c) further comprises an optional step of manually switching off said power unit by a manual switch of said vehicle collision recorder so as to deactivate said image capturer for stop capturing said motion image.

15. The method, as recited in claim 12, wherein the step (c) further comprises an optional step of manually switching off said power unit by a manual switch of said vehicle collision recorder so as to deactivate said image capturer for stop capturing said motion image.

16. The method, as recited in claim 13, wherein the step (c) further comprises an optional step of manually switching off said power unit by a manual switch of said vehicle collision recorder so as to deactivate said image capturer for stop capturing said motion image.

17. The method, as recited in claim 11, wherein the step (a) further comprises a step of electrically connecting said power unit to a power source of said vehicle such that said power unit is automatically switched on when said vehicle is started concurrently.

18. The method, as recited in claim 16, wherein the step (a) further comprises a step of electrically connecting said power unit to a power source of said vehicle such that said power unit is automatically switched on when said vehicle is started concurrently.

19. The method, as recited in claim 13, further comprising a step of extracting said video data out from said data storage through a data port of said vehicle collision recorder.

20. The method, as recited in claim 18, further comprising a step of extracting said video data out from said data storage through a data port of said vehicle collision recorder.
